(19) United States
(12) Patent Application Publication
(10) Pub. No.: US 2023/0244088 A1
(43) Pub. Date: Aug. 3, 2023

(54) Eyeglasses And Case Magnetically Attachable To Handheld Mobile Device

(71) Applicant: POPWEAR LLC, Austin, TX (US)

(72) Inventors: Chris Lyman, Austin, TX (US); Marc Smookler, Austin, TX (US)

(73) Assignee: POPWEAR LLC, Austin, TX (US)

(21) Appl. No.: 17/592,213

(22) Filed: Feb. 3, 2022

(51) Int. Cl. G02C 5/00; G02C 1/06; G02C 5/08; A45C 11/04; A45C 13/10

(52) U.S. Cl. CPC G02C 5/006; G02C 1/06; G02C 5/08; A45C 11/04; A45C 13/1069; G02C 2200/02; A45C 2011/002

(57) ABSTRACT

A system for magnetically mounting a pair of eyeglasses to a handheld mobile device, wherein the pair of eyeglasses has lenses, lens rims in which the lenses are supported, and a bridge connecting the lens rims, wherein at least one of the lens rims comprises a material attracted by a magnetic field, a handheld mobile device having a magnet that produces a magnetic field, wherein at least one of the lens rims is configured to coincide with the magnet of the handheld mobile device such that the lens rim is magnetically attachable to the handheld mobile device. Alternatively, an eyeglass case is magnetically mounted to the handheld mobile device.

### TECHNICAL FIELD

The present disclosure relates generally to the field of eyeglasses and cases for eyeglasses, in particular, eyeglasses and cases for eyeglasses that are magnetically attachable to a mobile phone.

### BACKGROUND

Smartphones are ubiquitous. A smartphone combines telephone and computing functions into one handheld mobile device. In addition to phone functions (voice communication and text messaging), smartphones may have hardware and operating systems that facilitate software programs, internet (including web browsing over mobile broadband), and multimedia functionality (music, video, photography, and gaming). Smart phones typically have a touch screen interface, camera, speaker, microphone, control buttons, and a charging/data port.

Smartphones may have wireless charging functionality based on Qi wireless power transfer standards. A base station powered by a household power supply may include a transmitter coil that generates a magnetic field from the alternating current. When the smartphone is placed in the magnetic field of the base station, a receiver coil inside the smartphone may be induced to charge the smartphone's battery by magnetic resonance charging. For example, smartphones sold by Apple (iPhone 12, iPhone 12 Pro, iPhone 13, and iPhone 13 Pro) use a MagSafe charger for wireless charging. MagSafe uses a circular arrangement of magnets placed around the iPhone's internal charging coil.

Eyewear such as eyeglasses, sunglasses, reading glasses, safety glasses, etc., may be configured in a variety of ways, some with a very thin design, to allow convenient carrying. Cases of various configurations have also been developed to protect the eyewear from damage which being carried. Some eyewear and/or cases attach to clothing, key chains, lanyards, etc. for convenient accessibility. Other eyewear and/or cases are designed to be carried in clothing pockets, purses, or handbags.

Smartphone cases have been designed to provide protection and allow convenient use. Such cases allow the smartphone to be connected to cables for charging and computer interconnections. Cases may accommodate wireless charging. Cases may have interfaces to hold or support the mobile phone while driving in a car or working at a work station such as a desk.

What is needed is a convenient way to carry reading eyeglasses with a smartphone.

### SUMMARY OF THE INVENTION

According to one aspect of the invention, a pair of eyeglasses magnetically attaches to a smartphone and another aspect provides a case for a pair of eyeglasses that magnetically attaches to a smartphone. Both embodiments may work with any magnetic phone using any magnetic pass-through case or not using a phone case at all.

According to another aspect of the invention, there is provided a pair of eyeglasses comprising: first and second lenses; first and second lens rims in which the first and second lenses are supported, respectively; and a bridge mechanically communicating with the first and second lens rims, wherein at least one of the first and second lens rims comprises a material attracted by magnetic field, wherein at least one of the first and second lens rims is configured to coincide with a magnet or magnet array of a handheld mobile device such that the lens rim is magnetically attachable to the handheld mobile device.

Another aspect of the invention provides a case for a pair of eyeglasses, the case comprising: a compartment for housing a pair of eyeglasses; and a mount comprising a material attracted by a magnetic field and configured to coincide with a magnet or magnet array of a handheld mobile device such that the case is magnetically attachable to the handheld mobile device via the mount.

According to yet another aspect of the invention, there is provided a system for magnetically mounting a pair of eyeglasses to a handheld mobile device, the system comprising: a pair of eyeglasses comprising: first and second lenses; first and second lens rims in which the first and second lenses are supported, respectively, wherein at least one of the first and second lens rims comprises a material attracted by a magnetic field; and a bridge mechanically communicating with the first and second lens rims, a handheld mobile device comprising a magnet that produces a magnetic field, wherein at least one of the first and second lens rims is configured to coincide with the magnet of the handheld mobile device such that the at least one of the first and second lens rims is magnetically attachable to the handheld mobile device.

### BRIEF DESCRIPTION OF THE DRAWINGS

A more complete understanding of the present embodiments may be acquired by referring to the following description taken in conjunction with the accompanying drawings, in which like reference numbers indicate like features. The invention is herein described, by way of example only, with reference to the accompanying drawings. The particulars shown in the drawings are exemplary and illustrative of preferred embodiments, and are presented to provide what is believed to be the most useful and readily understood description of the principles and conceptual aspects of the invention. The written description and the drawings inform those skilled in the art how the several forms of the invention may be embodied in practice.

FIG. 1A illustrates perspective views of a pair of eyeglasses in a folded configuration and a handheld mobile device having a ring of magnets.

FIG. 1B shows a perspective view of the pair of eyeglasses and handheld mobile device of FIG. 1A, wherein the eyeglasses are magnetically attached to the ring of magnets of the handheld mobile device.

FIG. 2A illustrates perspective views of a pair of eyeglasses in a folded configuration and a case for eyeglasses, wherein the case has a mount.

FIG. 2B shows a perspective view of the pair of eyeglasses and the case of FIG. 2A and a handheld mobile device, wherein the eyeglasses are positioned inside a compartment of the case and the case is magnetically attached to a handheld mobile device via the mount.

FIGS. 3A-3F show side views of magnets and magnet arrays that may be included in a handheld mobile device, a case, or a pair of eyeglasses for magnetic attachment.

FIG. 4A illustrates an example pair of eyeglasses in an unfolded configuration for use by a person.

FIG. 4B shows the pair of eyeglasses of FIG. 4A, in a folded configuration for magnetic attachment to a handheld mobile device or insertion into a compartment of a case.

FIG. 5A illustrates an example pair of Pince-Nez style eyeglasses in an unfolded configuration for use by a person.

FIG. 5B shows the pair of Pince-Nez style eyeglasses of FIG. 5A, in a folded configuration for magnetic attachment to a handheld mobile device or insertion into a compartment of a case.

FIG. 6 illustrates a case having a compartment for eyeglasses and a mount, wherein the mount is a ring array of magnets or a material that is attracted by a magnetic field.

### DETAILED DESCRIPTION

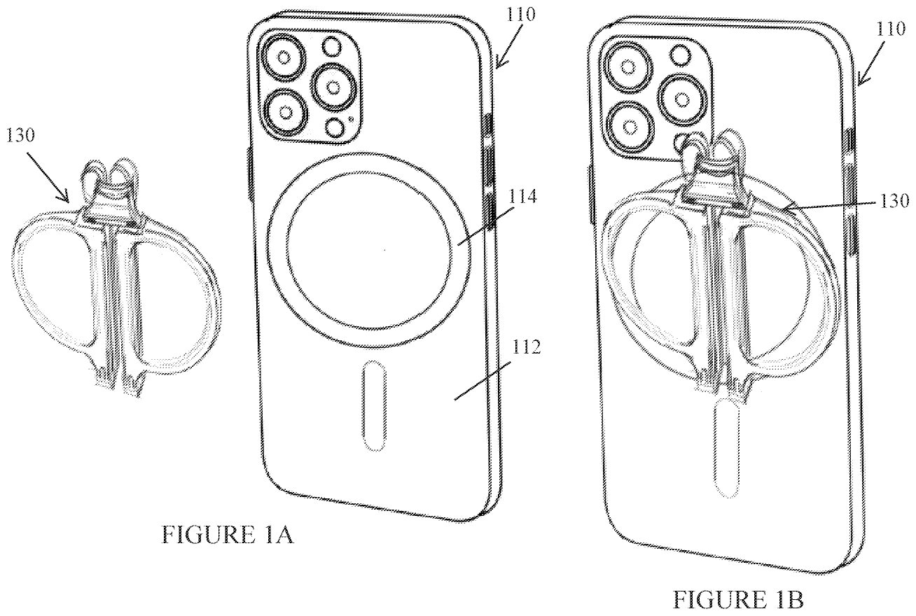

Preferred embodiments are best understood by reference to FIGS. 1-6 below in view of the following general discussion. The present disclosure may be more easily understood in the context of a high level description of certain embodiments. The invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

One aspect of the invention provides a pair of eyeglasses that magnetically attaches to a smartphone and another aspect provides a case for a pair of eyeglasses that magnetically attaches to a smartphone. Both embodiments may work with any magnetic phone using any magnetic pass-through case or not using a phone case at all. Cases for smartphones are well known and ubiquitous in the market. A case clips over the casing of a smartphone to provide an extra layer of protection beyond that provided by the smartphone casing or housing. The present invention may magnetically attach a pair of eyeglasses or an eyeglass case so a smartphone whether or not the smartphone has a protective case clipped to its casing or housing.

One aspect of the invention is to enable magnetic attachment of a pair of eyeglasses to a handheld mobile device, such as, for example, PDA, tablet, laptop, or smart phone, such as those manufactured by Apple (iPhone™, iPod™ iPad™), SAMSUNG (Galaxy), and Motorola (Moto).

Referring to FIG. 1A, a perspective view shows an handheld mobile device 110 comprising one or more magnets, and a pair of eyeglasses 130 in a folded configuration. The mobile device 110 may have a screen or other interface (not shown) on one side and a casing 112 on the other side. The mobile device 110 may also have one or more magnets 114 positioned relative to the casing 112 to allow a magnetic field to exist proximate the casing 112. The eyeglasses 130 shown in FIG. 1A have two lenses, two nose pads, and frames comprising two temple pieces. The frames are folded so that the lenses are side-by-side in the same plane. The eyeglasses 130 shown at a distance from the magnets 114 such that the eyeglasses 130 are effectively outside the magnetic field.

Referring to FIG. 1B, a perspective view of the handheld mobile device 110 and the pair of glasses 130 of FIG. 1A are shown, wherein the eyeglasses 130 are magnetically attached to the mobile device 110. The eyeglasses 130 comprise a material that is pulled toward the casing 112 when introduced into the magnetic field of the magnets 114, so that the glasses 130 are magnetically attached to the mobile device 110.

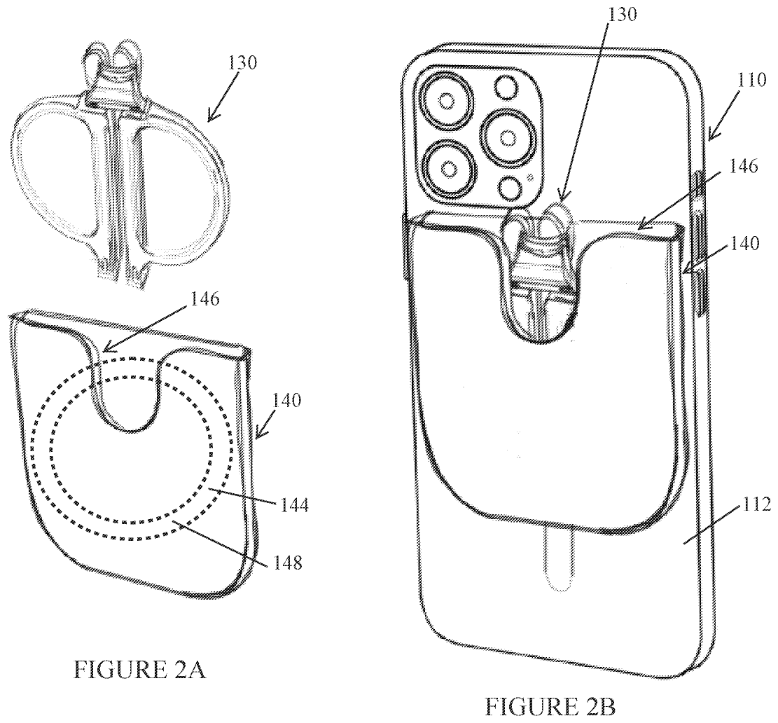

Referring to FIG. 2A, a perspective view shows a pair of eyeglasses 130 and a case 140. The pair of eyeglasses 130 has two lenses, two nose pads, and a frame comprising two temple pieces. The frame is folded so that the lenses are side-by-side in the same plane. The case 140 may be of a size and shape to allow the eyeglasses 130 to be placed within the case 140. The case may have one or more magnets, or a portion of the case may comprise a material that is attracted by a magnetic field.

Referring to FIG. 2B, a perspective view of the pair of eyeglasses 130 and case 140 of FIG. 2A are shown relative to a handheld mobile device 110, wherein the case 140 is magnetically attached to the mobile device 110. The pair of eyeglasses 130 are in a folded configuration and positioned within the case 140. The mobile device 110 may have a screen or other interface (not shown) on one side and a casing 112 on the other side. The mobile device 110 may also have one or more magnets 114 positioned relative to the casing 112 to allow a magnetic field to exist proximate the casing 112. The case 140 is positioned in contact with the casing 112 adjacent the magnets 114 such that the case 140 is effectively within the magnetic field and attached to the casing 112.

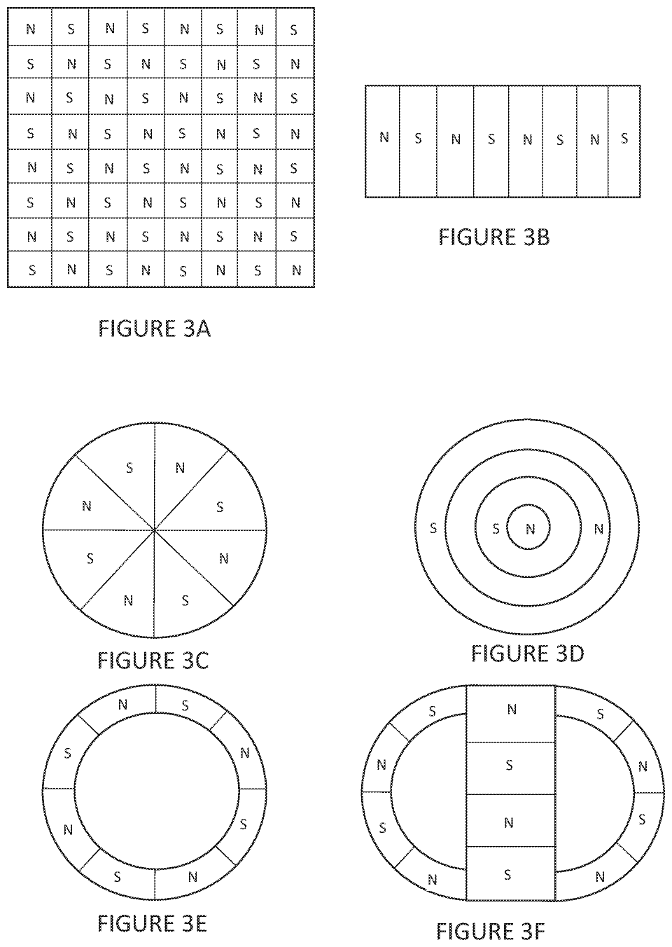

FIGS. 3A-3F show various magnets or magnet arrays 114 of the mobile device 110 positioned in various arrangements to interact with the eyeglasses 130 or case 140. In FIG. 3A, a two-dimensional square array of magnets is positioned with North and South poles adjacent each other across the array. In FIG. 3B, a linear array of magnets is positioned with North and South poles adjacent each other alternating down the line. FIG. 3C shows a pizza-shaped array wherein North and South poles of magnets each take the shape of a “pizza slice” cut at about 45 degrees and alternate positions around the “pizza.” FIG. 3D illustrates a “bull's eye target” shaped magnet array wherein the North and South poles are ring-shaped and positioned as concentric circles. FIG. 3E shows a magnet array in a circular or ring arrangement similar to a MagSafe (used in smartphones sold by Apple) charger for wireless charging. MagSafe uses a circular arrangement of magnets placed around the iPhone's internal charging coil. FIG. 3F illustrates a custom magnetic array having a shape similar to a pair of eyeglasses, wherein in this particular illustration, the array has two semi-circular portions separated by a linear portion. The magnets or magnet arrays shown in FIGS. 3A-3F may also comprise the magnets or magnet arrays 144 of the case 140. The magnets or magnet arrays shown in FIGS. 3A-3F may also comprise the magnets or magnet arrays of the eyeglasses.

The array of magnets may be incorporated into the smartphone, such as example, smartphones sold by Apple (iPhone 12, iPhone 12 Pro, iPhone 13, and iPhone 13 Pro) use a MagSafe charger for wireless charging. MagSafe uses a circular arrangement of magnets placed around the iPhone's internal charging coil. The eyeglasses or case for eyeglasses may magnetically attach directly to the MagSafe magnets whether or not the iPhone has a protective case clipped to its exterior housing or casing.

Alternatively, if the smartphone does not have an internal array of magnets, the array of magnets 114 may be glued or adhered to the casing or housing of any smartphone to provide a magnetic field for magnetically attaching a pair of eyeglasses or a case with a mount. Also, protective cases for smartphones are well known and ubiquitous in the market. A protective case clips over the casing of a smartphone to provide an extra layer of protection beyond that provided by the smartphone casing or housing. The array of magnets 114 may be glued or adhered to a protective case that clips over the casing of a smartphone. Alternatively, the array of magnets 114 may be molded into a protective case that clips over the casing of a smartphone. Any method or process known to persons of skill may be used to make the array of magnets part of a protective case that clips over the casing of a smartphone.

The present invention may magnetically attach a pair of eyeglasses or an eyeglass case to a smartphone whether or not the smartphone has a protective case clipped to its casing or housing.

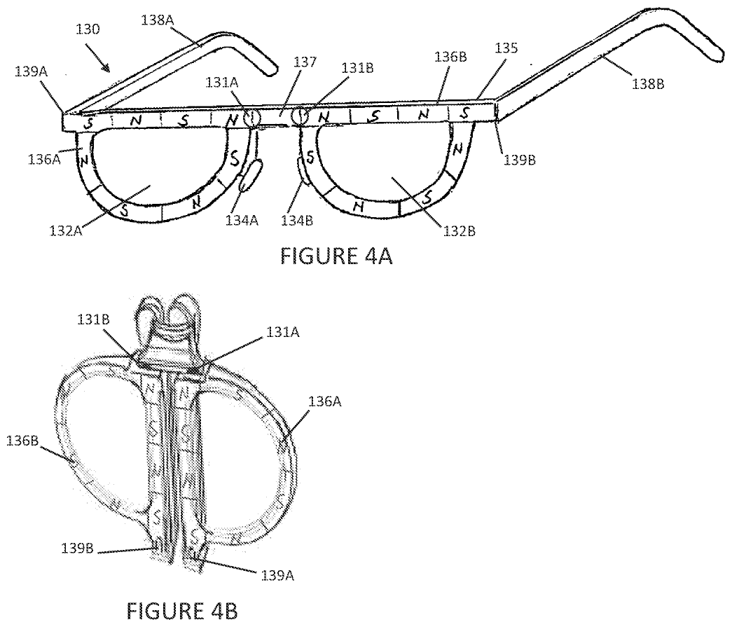

The eyeglasses 130 and/or case 140 may comprise a ferromagnetic material or other material that is pulled toward the casing 112 when introduced into the magnetic field of the magnets 114, so that the eyeglasses 130 and/or case 140 may be magnetically attached to the mobile device 110. For example, FIGS. 4A and 4B show a pair of eyeglasses 130 in unfolded and folded configurations, respectively. The pair of eyeglasses 130 has two lenses 132A and 132B, two nose pads 134A and 134B, and a frame 136. The frame 135 has lens rims 136A and 136B connected by a bridge 137, and temple pieces 138A and 138B connected to the lens rims 136A and 136B via temple hinges 139A and 139B. The frame 135 may comprise a magnet array, such as is illustrated in FIGS. 4A and 4B, wherein North and South poles of magnets are positioned around the lens rims 136A and 136B. The magnet poles of the pair of eyeglasses 130 may be opposite of magnet poles of the mobile device 110 so as to provide attractive force between the eyeglasses and the mobile device 110. For example, the magnet poles of the pair of eyeglasses 130 shown in FIG. 4B may be opposite of magnet poles of the mobile device 110 shown in FIG. 3F.

FIGS. 4A and 4B illustrate that the pair of eyeglasses 130 may have bridge hinges 131A and 131B at the connection points between the bridge 137 and the lens rims 136A and 136B that enable the frame to move between folded and unfolded configurations. The lens rims 136A and 136B remain in the same plane in both configurations. The temple/ear pieces 138A and 138B may be folded against the lens rims 136A and 136B via temple hinges 139A and 139B. Additional hinges may be positioned in the temple/ear pieces 138A and 138B to allow for additional folds to enable a compact folded configuration. The nose pads nose pads 134A and 134B may also be made to fold via hinges, depending on the configuration, wherein the nose pads 134A and 134B may extend from the lens rims 136A and 136B or the bridge 137.

The eyeglasses and/or case may comprise ferromagnetic materials or even paramagnetic materials. Ferromagnetic materials, e.g., iron, steel, cobalt, nickel, are strongly attracted to permanent magnets. Paramagnetic materials, e.g., tungsten, aluminum, are weakly attracted to permanent magnets.

Alternatively, eyeglasses 130 or case 140 may comprise a permanent magnet or magnets 114 and the handheld mobile device 110 comprises a casing 112 with ferromagnetic materials or even paramagnetic materials.

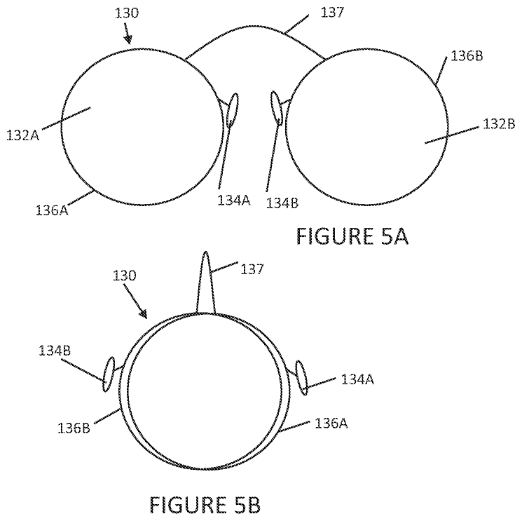

The pair of eyeglasses 130 may be Pince-Nez style eyeglasses that does not have temple/ear pieces and merely rests on and/or pinches the bridge of the nose. FIGS. 5A and 5B illustrate a pair of Pince-Nez style eyeglasses having lenses 132A and 132B, nose pads 134A and 134B, and lens rims 136A and 136B connected by a bridge 137. FIG. 5A shows the eyeglasses 130 unfolded in a configuration ready to be worn by the user. FIG. 5B shows the eyeglasses 130 folded so that the lens rims 136A and 136B are nearly positioned adjacent each other. The bridge 137 may comprise a flexible, bendable material that allows the pair of eyeglasses to transition between the folded and unfolded configurations, wherein it may be biased to the unfolded configuration. The bridge 137 may comprise any material known to those of skill in the art, including ductile metals. The bridge 137 may be made of nitinol (nickel titanium) wire, which can be heat formed into the appropriate shape (produced by Nitinol Devices & Components of Freemont, Calif.). The bridge 137 may be a spring. In a folded configuration, the pair of eyeglasses 130 shown in FIG. 5B may be positioned in the magnetic field of any one of magnetic arrays shown in FIGS. 3C-3E to magnetically attached the pair of eyeglasses 130 to a casing 112 of a mobile device 110, wherein the magnets attract both lens rims 136A and 136B. The lens rims 136A and 136B may comprise one or more ferromagnetic materials and/or one or more paramagnetic materials. Alternatively, the lens rims 136A and 136B may comprise permanent magnets that have North and South poles opposite the North and South poles shown in FIGS. 3C-3E.

In an alternative embodiment, a Pince-Nez style pair of eyeglasses may be foldable for positioning in a case that is magnetically attached to a casing of a handheld mobile device.

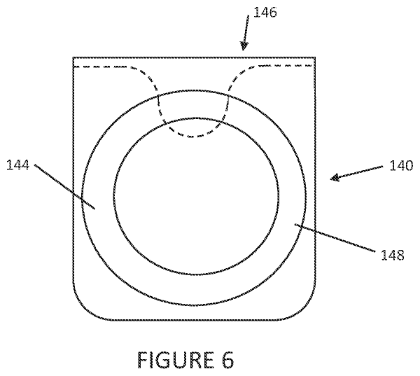

Cases of the present invention may be configured to perform three functions. First, they may magnetically attach to a casing of a handheld mobile device. Second, they may provide a compartment 146 or other structural feature to store a pair of eyeglasses, magnifying glass, or monocle. Third, they may allow for recharging the battery of the handheld mobile device by placing the device in proximity of a wireless charger, even when the case is magnetically attached to the casing. A case 140 may have a compartment 146 for housing the pair of eyeglasses. As shown in FIG. 6, a case 140 may comprise a mount 148 having a magnet or an array of magnets 144 for magnetic interaction with a magnet or an array of magnets of a handheld mobile device 110. Alternatively, a case 140 may comprise a mount 148 made of a ferromagnetic material or paramagnetic material in a geometric shape that coincides with a magnet or array of magnets of a handheld mobile device.

The lenses and lens rims of the present invention may be configured in a variety of shapes and sizes as are well known in the industry. The lens rims may or may not completely encircle the lenses. In some configurations, the lens rims may only be positioned at the periphery of the lenses about a portion of the lens circumferences.

Although the disclosed embodiments are described in detail in the present disclosure, it should be understood that various changes, substitutions and alterations can be made to the embodiments without departing from their spirit and scope.

What is claimed is:

1. A pair of eyeglasses comprising:
first and second lenses;
first and second lens rims in which the first and second lenses are supported, respectively; and
a bridge mechanically communicating with the first and second lens rims,
wherein at least one of the first and second lens rims comprises a material attracted by a magnetic field,
wherein at least one of the first and second lens rims is configured to coincide with a magnet or magnet array of a handheld mobile device such that the lens rim is magnetically attachable to the handheld mobile device.

2. A pair of eyeglasses as claimed in claim 1, wherein the first and second lens rims completely encircle the first second lenses, respectively.

3. A pair of eyeglasses as claimed in claim 1, wherein at least one of the first and second lens rims comprises at least one magnet.

4. A pair of eyeglasses as claimed in claim 1, wherein at least one of the first and second lens rims comprises an array of magnets.

5. A pair of eyeglasses as claimed in claim 1, wherein the bridge is flexible to allow the first and second lens rims to move between folded and unfolded configurations.

6. A pair of eyeglasses as claimed in claim 1, further comprising first and second bridge hinges in mechanical communication with the first and second lens rims via the bridge, respectively, wherein the first and second bridge hinges allow the first and second lens rims to move between folded and unfolded configurations, wherein the first and second lens rims are maintained in a single plane in both the folded and unfolded configurations.

7. A pair of eyeglasses as claimed in claim 1, further comprising first and second temple pieces in mechanical communication with the first and second lens rims via first and second temple hinges, respectively.

8. A pair of eyeglasses as claimed in claim 1, wherein the first and second lens rims have generally semi-circular shapes.

9. A case for a pair of eyeglasses that is mountable to a handheld mobile device, the case comprising:
a compartment for housing a pair of eyeglasses; and
an annular-shaped mount comprising a material attracted by a magnetic field and configured to coincide with a ring array of magnets of a handheld mobile device such that the case is magnetically attachable to the handheld mobile device via the mount.

10. A case for a pair of eyeglasses as claimed in claim 9, wherein the mount comprises at least one permanent magnet.

11. A case for a pair of eyeglasses as claimed in claim 9, wherein the mount comprises an array of permanent magnets.

12. A case for a pair of eyeglasses as claimed in claim 9, wherein the mount comprises an array of permanent magnets with alternating North and South poles.

13. A case for a pair of eyeglasses as claimed in claim 9, wherein the case further comprises a housing defining the compartment, wherein the housing has an opening for receiving the pair of eyeglasses into the compartment.

14. A system for magnetically mounting a pair of eyeglasses to a handheld mobile device, the system comprising:
a pair of eyeglasses comprising:
first and second lenses;
first and second lens rims in which the first and second lenses are supported, respectively, wherein at least one of the first and second lens rims comprises a material attracted by a magnetic field; and
a bridge mechanically communicating with the first and second lens rims,
a handheld mobile device comprising a magnet that produces a magnetic field,
wherein at least one of the first and second lens rims is configured to coincide with the magnet of the handheld mobile device such that the at least one of the first and second lens rims is magnetically attachable to the handheld mobile device.

15. A system for magnetically mounting a pair of eyeglasses to a handheld mobile device, as claimed in claim 14, wherein at least one of the first and second lens rims comprises at least one magnet.

16. A system for magnetically mounting a pair of eyeglasses to a handheld mobile device, as claimed in claim 14, wherein the bridge is flexible to allow the first and second lens rims to move between folded and unfolded configurations.

17. A system for magnetically mounting a pair of eyeglasses to a handheld mobile device, as claimed in claim 14, further comprising first and second bridge hinges in mechanical communication with the first and second lens rims via the bridge, respectively, wherein the first and second bridge hinges allow the first and second lens rims to move between folded and unfolded configurations, wherein the first and second lens rims are maintained in a single plane in both the folded and unfolded configurations.

18. A system for magnetically mounting a pair of eyeglasses to a handheld mobile device, as claimed in claim 14, further comprising first and second temple pieces in mechanical communication with the first and second lens rims via first and second temple hinges, respectively.

19. A system for magnetically mounting a pair of eyeglasses to a handheld mobile device, as claimed in claim 14, wherein the first and second lens rims have generally semi-circular shapes.

20. A system for magnetically mounting a pair of eyeglasses to a handheld mobile device, as claimed in claim 14, wherein the magnet of the handheld mobile device comprises a ring of magnets.
